(19) United States
(12) Patent Application Publication
(10) Pub. No.: US 2025/0227340 A1
(43) Pub. Date: Jul. 10, 2025

(54) METHOD, SERVER, AND USER TERMINAL FOR PROVIDING RELAY CONTENT

(71) Applicant: KAKAO CORP., Jeju-si (KR)

(72) Inventors: Woo Ram PARK, Seongnam-si (KR); Sang Hoon LEE, Seongnam-si (KR); Dong Hyun KIM, Seongnam-si (KR); Jung Yeon LEE, Seongnam-si (KR)

(21) Appl. No.: 18/968,622

(22) Filed: Dec. 4, 2024

(30) Foreign Application Priority Data
Jan. 5, 2024 (KR) 10-2024-0002463

(51) Int. Cl. H04N 21/4722; H04N 21/24; H04N 21/262

(52) U.S. Cl. CPC H04N 21/4722; H04N 21/2407; H04N 21/262

(57) ABSTRACT

Proposed is a method for providing a relay content by a server. The method may include providing a source content to a first user terminal, determining whether the first user terminal plays the source content while meeting a relay content playback condition, and providing at least one relay content to the first user terminal. The at least one relay content may be subordinate to the source content, and the source content and the at least one relay content may be provided by different users.

### CROSS-REFERENCE TO RELATED APPLICATION

This application claims priority to and the benefit of Korean Patent Application No. 10-2024-0002463 filed on Jan. 5, 2024, the disclosure of which is incorporated herein by reference in its entirety.

### BACKGROUND

### Technical Field

The present disclosure relates to a method for providing a content to a user terminal and continuously providing other contents associated with the content.

### Description of Related Technology

With the development of mobile communication and portable device technologies, content provision services, such as video streaming over the Internet, have become widespread. Recent content provision services are characterized by the continuous playback of short-form videos, providing compressed information with a fast content flow. These short-form videos align with the trend of casual content consumption and allow users to quickly access information and enjoy engaging content.

### SUMMARY

One aspect is to provide a source content and a relay content to be played continuously based on selection for one of multiple choices related to the source content.

Another aspect is a method for providing a relay content subordinate to a source content, with a relay point being included in the source content to specify a point at which the relay content is uploaded or played.

Another aspect is a method for providing a relay content by a server, the method including: providing a source content to a first user terminal; determining whether the first user terminal plays the source content while meeting a relay content playback condition; and providing at least one relay content to the first user terminal. The at least one relay content is subordinate to the source content, and the source content and the at least one relay content are provided by different users.

The at least one relay content may be received from a second user terminal after the server provides at least a part of the source content to the second user terminal.

The relay content playback condition may be associated with whether the first user terminal plays a predetermined relay point in the source content.

The predetermined relay point may be associated with at least one of a specific point and a specific segment in the source content.

Providing the at least one relay content may include: providing a playback interface for the at least one relay content to the first user terminal; and in response to receiving an interaction with the interface from the first user terminal, providing the at least one relay content to the first user terminal.

The interface may be a selection interface for selecting one of multiple choices, and the relay content may be associated with the choice selected by the interaction.

The selection interface may include profile information of at least one user among users providing relay contents associated with the multiple choices.

The profile information may be determined based on a relationship between a first user and the at least one user corresponding to the profile information. The relationship may be established in relation to a service through which the server provides contents.

In providing the at least one relay content, the server may sequentially provide multiple relay contents, and the multiple relay contents may be subordinate to the source content.

A playback order of the multiple relay contents may be determined based on a relationship between the first user and users providing the multiple relay contents. The relationship may be established in relation to a service through which the server provides contents.

Providing the at least one relay content may include providing information about the source content along with the at least one relay content.

The method may further include, after providing the source content, providing the first user terminal with an interface for providing a new relay content subordinate to the source content to the server.

The interface may be a selection interface for selecting one of multiple choices, and the new relay content may be associated with a choice selected through an interaction with the selection interface.

The method may further include, after providing the at least one relay content: determining whether the first user terminal plays a specific relay content while meeting a secondary relay content playback condition; and providing at least one secondary relay content to the first user terminal. The secondary relay content may be subordinate to the specific relay content, and the specific relay content and the secondary relay content may be provided by different users.

Providing the at least one secondary relay content may include providing information about at least one of the source content and the relay content being played, along with the secondary relay content.

Another aspect is a server providing a relay content, the server including a memory storing instructions, and a processor connected to the memory and configured to execute the instructions to: provide a source content to a first user terminal; determine whether the first user terminal plays the source content while meeting a relay content playback condition; and provide at least one relay content to the first user terminal. The at least one relay content is subordinate to the source content, and the source content and the at least one relay content are provided by different users.

Another aspect is a method for displaying a relay content by a user terminal, the method including: displaying a source content provided to a server by another user terminal; and displaying an interface for providing a new relay content subordinate to the source content to the server.

The interface may be a selection interface for selecting one of multiple choices, and the new relay content may be associated with a choice selected through an interaction with the selection interface.

The method may further include: in response to displaying the source content while meeting a relay content playback condition, displaying a relay content playback interface; and in response to receiving an interaction with the relay content playback interface, displaying at least one relay content.

The playback interface may be a selection interface for selecting one of multiple choices, and the relay content is associated with a choice selected through the interaction.

Another aspect is a user terminal displaying a relay content, the user terminal comprising a memory storing instructions, and a processor connected to the memory and configured to execute the instructions to: display a source content provided to a server by another user terminal; and display an interface for providing a new relay content subordinate to the source content to the server.

### BRIEF DESCRIPTION OF THE DRAWINGS

FIG. 1 is a diagram illustrating an example of a network environment according to one embodiment of the present disclosure.

FIG. 2 is a flowchart illustrating a method for providing source content and relay content by a server of the present disclosure.

FIG. 3 is a table exemplifying a database of content held by a server.

FIGS. 4 to 10 illustrate screens of a user terminal according to one embodiment of the present disclosure.

FIG. 11 is a flowchart illustrating a method for providing a new relay content to a server by a user terminal of the present disclosure.

FIGS. 12 and 13 illustrate screens of a user terminal according to one embodiment of the present disclosure.

FIG. 14 is a flowchart illustrating a method for providing at least one secondary relay content to a first user terminal by a server of the present disclosure.

FIGS. 15 and 16 illustrate screens of a user terminal according to one embodiment of the present disclosure.

FIG. 17 is a flowchart illustrating a method for displaying source content and relay content by a user terminal of the present disclosure.

### DETAILED DESCRIPTION

Recent content provision services provide unconventional ways for users to interact. Specifically, while content provision services primarily support reactions through text comments, the recent services enable users to react with non-text images, emoticons, and even participate in surveys by selecting choices.

In addition to simple content provision, the recent content provision services also enable users to build social networks. Therefore, a new method is required to recommend content based on user relationships within a content provision service, thereby strengthening the interconnectedness of content.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms, unless the context clearly indicates a different meaning.

In this application, the described steps may be carried out in any sequence, except in cases where a clearly defined cause-and-effect relationship necessitates a specific order.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described with reference to the accompanying drawings.

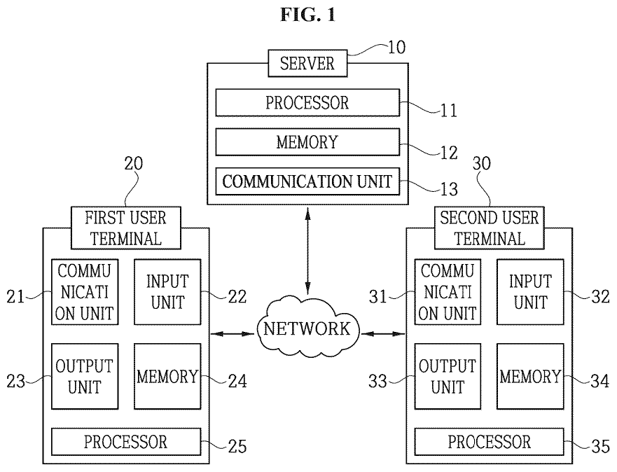

FIG. 1 is a diagram illustrating an example of a network environment according to one embodiment of the present disclosure.

A network environment according to one embodiment of the present disclosure illustrated in FIG. 1 may include a server 10 and user terminals 20 and 30. The user terminals 20 and 30 may include at least one user terminal 20 or 30 connected to the server 10 over a network. In FIG. 1, a first user terminal 20 and a second user terminal 30 are illustratively shown as the user terminals 20 and 30.

The first user terminal 20 refers to a terminal that a first user logs into using the first user's account registered on the server 10, while the second user terminal 30 refers to a terminal that a second user logs into using the second user's account registered on the server 10.

Hereinafter, for convenience of explanation, the first user terminal 20 will be described as a terminal that plays a source content, relay contents, and secondary relay contents. In addition, the second user terminal 30 will be described as a terminal that provides a relay content to the server 10. Here, the first user terminal 20 may not only play the source content but also provide a relay content subordinate to the source content or a secondary relay content subordinate to the relay content to the server 10. However, the present disclosure does not specify or limit the functions that may be performed by the user terminals 20 and 30.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be a device capable of transmitting and receiving information through communication with the user terminals 20 and 30 over a network. The server 10 may be implemented as a computer device or a plurality of computer devices that provide commands, codes, files, content, services, etc.

The server 10 may include a processor 11, a memory 12, and a communication unit 13.

The processor 11 controls the overall operation of the memory 12 and the communication unit 13 to provide a service of providing content to the user terminal 20, 30 and to store the content. A content playback service provides a function to play a content and to provide and playback another content as subordinate to the content.

The memory 12 functions as a storage medium and may store a number of application programs running on the server 10, as well as data and commands for operation of the server 10. In one embodiment, the memory 12 may store an application that provides a platform service, social media service, or messenger service through which a content can be played or shared.

This memory 12 may be provided in the form of any of various hardware storage devices such as an ROM, an RAM, a flash drive, a hard drive, etc. or may be provided in the form of web storage.

The communication unit 13 may communicate with a user terminal in a wired/wireless manner over a network.

The server 10 of the present disclosure may provide the user terminals 20a and 30 with a source content and a relay content subordinate to the source content. In addition, the server 10 may provide the user terminals 20a and 30 with the functionality to provide a relay content as subordinate to the source content.

Users who receive any functionality or service from the server 10 of the present disclosure may be connected through a friendship relationship. The friendship relationship may be formed by users sending and accepting friend requests such as at least one of the two users saving the other's phone number, or by requesting or accepting to receive activities or updates about a particular user from a social media service. In some cases, the functionality to provide an additional content as subordinate to an existing content may also enable services for users who are not friends.

The server 10 may provide a source content to the first user terminal 20. When the server 10 determines that the first user terminal 20 plays the source content while meeting a relay content playback condition, the server 10 may provide at least one relay content to the first user terminal 20. Here, the relay content is subordinate to the source content, and the source content and the relay content may be provided by different users.

Here, content may be information including text, photos, videos, motion pictures, multimedia information, or the like.

Here, a source content refers to a content to which any relay contents may be subordinate. The source content may have one or more subordinate contents connected thereto. The source content may be a content that is not subordinate to any other contents.

However, in some cases, the source content may also be a relay content. In this case, the first user terminal 20 may receive the source content in the form of a relay content for another content. However, in some cases, the first user terminal 20 may receive the source content in the form (e.g., a first item in a playlist) other than a relay content.

Here, a relay content refers to a content that is subordinate to a source content. That is, a relay content is defined as a content that is subordinate to another content designated as a source content when the server 10 receives the relay content from a relay content provider terminal. A single source content may have one or more relay contents subordinate to thereto.

The relay content provided by the server 10 to the first user terminal 20 may be received from the second user terminal 20. A source content provider and the relay content provider may be different users. Specifically, after receiving and playing the source content from the server 10, the second user terminal 30 may provide a relay content subordinate to the source content to the server 10. However, in the present disclosure, it is not excluded that the source content and the relay content may be provided by the same user.

A relay content may be connected to a specific point in the source content. In the present disclosure, the specific point within the source content where the source content and the relay content are connected is referred to as a relay point. That is, a relay point may be a specific point or segment within a source content. For example, if a source content is a video, a relay point may be set at 1 minute and 12 seconds or at the last 5 seconds before the end. In another example, if a source content is a collection of images (e.g., webtoons or cartoons), a relay point may be set at 80% through the images or at the last page of a 30-page collection. The source content provider may provide a source content to the server 10 with a relay point designated in the source content.

There may be another relay content subordinate to the relay content. In the present disclosure, such another relay content is referred to as a secondary relay content. In this case, the relay content may also be understood as a source content for the secondary relay content. Based on this sequential dependency relationship, the relay content may be connected to a higher-order relay content, such as a tertiary or quaternary relay content.

Here, a relay content playback condition refers to a prerequisite for the server 10 to provide a corresponding relay content to the first user terminal 20. While the first user terminal 20 plays a source content received from the server 10, if a predetermined playback condition related to the source content is met, the first user terminal 20 may then receive a relay content subordinate to the source content from the server 10 and play the received relay content.

The playback condition related to the source content may be associated with whether the first user terminal 20 plays a specific point in the source content. Here, the specific point associated with the playback condition may be the same as the aforementioned relay point within the source content. Accordingly, as in the example described above, if the source content is a video content and the relay point is at 1 minute and 12 seconds, when the first user terminal 20 plays the point at 1 minute and 12 seconds of the source content, the server 10 may determine that the playback condition is met.

In the present disclosure, the first user terminal 20 may not only play a content provided by the server 10, but also provide a new content to the server 10. Specifically, the first user terminal 20 (or the first user) may provide a source content and a relay content to the server 10. The first user terminal 20 providing a content to the server 10 may be understood as the first user terminal uploading a content held or generated by the first user terminal 20 to the server 10, or the first user terminal 20 providing link information about a content, rather than the content file itself, to the server 10.

The first user terminal 20 may playback a source content, a relay content, and a secondary relay content, and provide a new relay content subordinate to the source content or relay content to the server 10.

The second user terminal 30 may provide a relay content being played by the first user terminal 20 to the server 10.

The first and second user terminals 20, 30 may include communication units 21 and 31, input units 22 and 32, output units 23 and 33, memories 24 and 34, and processors 25 and 35.

The communication units 21 and 31 may communicate with the server 10 or other terminals in a wired/wireless manner.

The input units 22 and 32 may receive various information through a user's operation and input. The input units 22 and 32 may be touch screen modules, keyboards, mouses, buttons, cameras, styluses, microphones, etc.

The user terminal 20, 30 may receive a user interaction through the input units 22 and 32. The interaction refers to the action of the user's operating an input unit to enter information reflecting the user's selection or intention into a user terminal. For example, the interaction may include touching on a touchscreen, clicking with a mouse, typing on a keyboard, providing voice input through a microphone, capturing an image using a camera, recognizing movements through a motion sensor, and the like.

The output units 23 and 33 may output various information. The output units 23 and 33 may be display devices, speakers, vibration generating devices, tactile generating devices, etc. In some cases, the output units 23 and 33 may be devices (e.g., Bluetooth earphone) respectively connected to the user terminals 20 and 30 through wired or wireless communication (e.g., short-range radio communication such as Bluetooth) to receive and output signals.

Each of the memories 24 and 34 functions as a storage medium and may store a plurality of application programs running on a corresponding one of the user terminal 20 and 30, as well as and data and instructions for operating the corresponding one of the user terminal 20 and 30. Each of the memories 24 and 34 may be provided in the form of any of various hardware storage devices such as an ROM, an RAM, a flash drive, a hard drive, etc. or may be provided in the form of web storage.

In one embodiment, the memories 24 and 34 may store an application that provides a platform service, social media service, or messenger service through which a content can be played or shared.

The processors 25 and 35 may control the overall operation of the communication units 21 and 31, input units 22 and 32, output units 23 and 33, and memories 24 and 34 to execute an application related to a platform service, social media service, or messenger service through which a content can be played or shared.

The first user terminal 20 displays a source content, and if a playback condition for any relay content subordinate to the source content is met, the first user terminal 20 may display at least one relay content. Here, any relay content are generated as subordinate to the source content, and the relay content and the source content may be transmitted to the server 10 from different terminals.

The second user terminal 30 may display the source content provided to the server 10 by another user terminal and may display an interface (hereinafter referred to as a “new relay registration interface”) for providing a new relay content subordinate to the source content to the server 10.

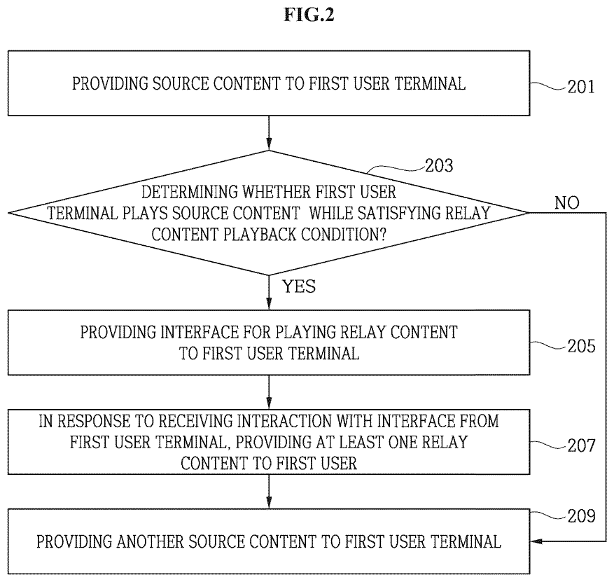

Hereinafter, an example of a method for providing a relay content by the server 10 of the present disclosure will be described with reference to FIG. 2.

FIG. 2 is a flowchart for explaining a method for providing a source content and a relay content by the server 10 of the present disclosure. First, a method for providing a relay content, performed between a server 10 and user terminals 20 and 30, will be described with reference to FIG. 2.

First, the server 10's operation before operation 201 will be described.

Before operation 201, the server 10 may be ready to provide a source content and a relay content for the source content to a first user terminal 20.

Specifically, before operation 201, the server 10 may receive the source content from a source content provider terminal.

While receiving the source content from the source content provider terminal, the server 10 may also receive information on whether uploading any relay content for the source content is allowed.

In addition, the server 10 may receive information about a relay point in the source content while receiving the source content from the source content provider terminal. For example, if the source content is a video that is 1 minute and 30 seconds long, the server 10 may receive information indicating that the relay point is set at 1 minute and 12 seconds or at the last 10 seconds before the end (from 1 minute and 20 seconds to 1 minute and 30 seconds). Two or more relay points may be set within a single source content. The relay points may serve as the criteria for determining whether the playback conditions for respective relay contents for the source content are met.

In addition, before operation 201, the server 10 may receive a relay content subordinate to the source content from a relay content provider terminal. The server 10 may receive multiple relay contents subordinate to a single source content from different terminals. At least one of the relay content provider terminals may be a second user terminal 30.

In operation 201, the server 10 provides the source content to the first user terminal 20.

The server 10 may provide the source content to the first user terminal 20 upon a request or the like from the first user terminal 20. The first user terminal 20 may play the source content provided by the server 10.

In operation 203, the server 10 determines whether the first user terminal 20 plays the source content while meeting a relay content playback condition.

The server 10 may receive playback information about the source content from the first user terminal 20. The server 10 may determine whether the first user terminal 20 meets the relay content playback condition based on the received playback information about the source content. When it is determined that the relay content playback condition is met, operation 205 is subsequently performed, and a relay content playback interface is provided to the first user terminal 20.

If the first user terminal 20 stops playing the source content or requests to play another content, it may be determined that the relay content playback condition is not met. In this case, operation 209 is performed, and the server 10 may stop providing the source content to the first user terminal 20 or may provide another source content.

In operation 205, the server 10 provides an interface for playing a relay content (hereinafter referred to as “relay playback interface”) to the first user terminal 20.

When the server 10 determines in operation 203 that the first user terminal 20 plays the source content while meeting the relay content playback condition, the server 10 may provide the relay playback interface to the first user terminal 20. The first user terminal 20 may display the relay playback interface on a screen where the source content is being played.

The relay playback interface may include a variety of things. For example, the relay playback interface may be an interface that guides a user to a relay content subordinate and connected to a corresponding relay point in the source content and inquires whether the user wants to play the relay content.

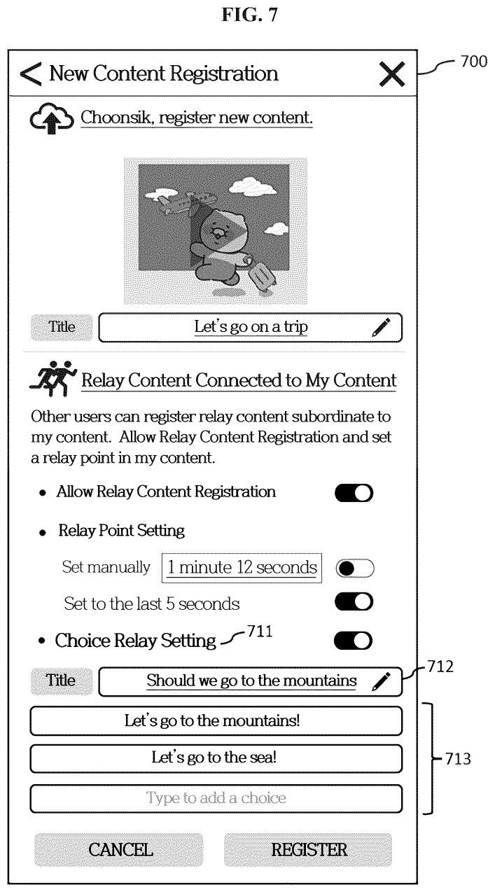

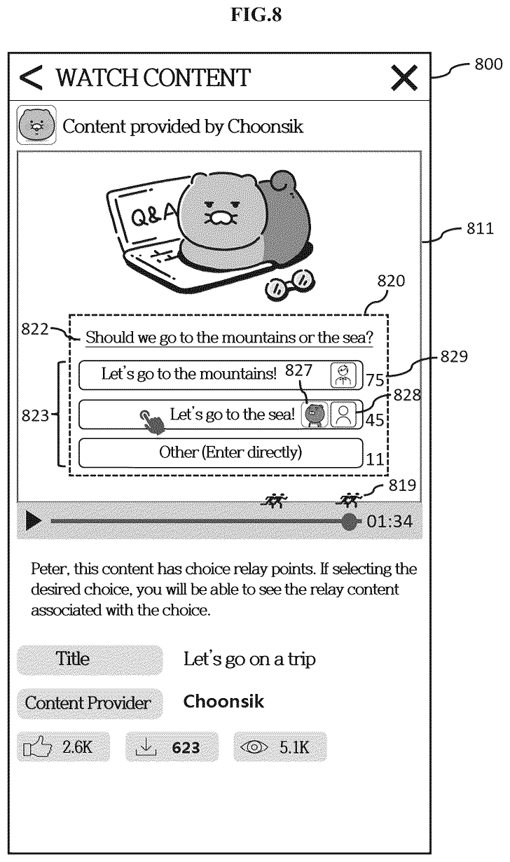

In another example, the relay playback interface may be a selection interface for selecting one of multiple choices. To this end, the source content prior to the relay point may include questions about the multiple choices. The server 10 may provide different relay contents depending on a user's selection in the selection interface. The relay playback interface being a selection interface will be described in more detail with reference to FIGS. 7 and 8 below.

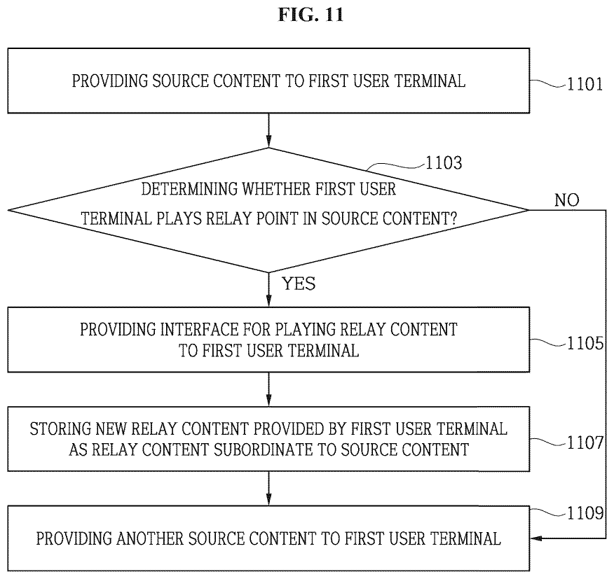

In yet another example, the relay playback interface may include, in addition to information regarding the playback of the relay interface, information regarding the first user terminal 20 providing a new relay content subordinate to the source content to the server 10. How the first user terminal 20 provides a new relay content to the server 10 will be described in more detail with reference to FIGS. 11 to 13.

The relay playback interface may be displayed on the first user terminal 20 in various ways. For example, the relay playback interface may be displayed overlapping an area where the source content is shown. According to this display method, the relay playback interface may be displayed to the first user with priority over the source content and may immediately inquire whether to play a corresponding relay content.

In another example, the relay playback interface may be displayed separately in a different area from where the source content is shown. According to this display method, the relay playback interface may be displayed to the first user as additional information regarding the source content, without interfering with the first user's watching of the source content.

The relay playback interface may disappear and no longer be displayed if no interaction is received within a predetermined time after the relay playback interface appears on the first user terminal 20. This may be because the absence of interaction is interpreted as a lack of intention to play a relay content, which leads to a follow-up action. In such cases, if the source content has not yet ended, the source content may continue to be played, and if the source content ends, another content may be played.

If the server 10 determines that the first user terminal 20 plays the source content while meeting the relay content playback condition, but there is no relay content subordinate to the source content, then no relay content may not be provided.

In addition, if the first user terminal 20 does not meet a playback condition for the source content and either stops playing the source content or requests to play another content, the relay playback interface may not be displayed. In this case, the first user terminal 20 may perform a follow-up action (stopping playback of the source content or playing another content) upon a request from the first user.

In operation 207, when the server 10 receives an interaction with the relay playback interface from the first user terminal 20, the server 10 provides at least one relay content to the first user terminal 20.

The server 10 may receive an interaction with the relay playback interface from the first user terminal 20. An interaction with the relay playback interface may be an interaction requesting playback of a relay content subordinate to a source content.

When multiple relay contents are subordinate to a source content, the server 10 may first provide one selected relay content to the first user terminal 20 according to a predetermined method. Here, the relay content provided to the first user terminal 20 may be a content provided by the second user terminal 30 to the server 10.

For example, if the relay playback interface is a selection interface for selecting one of multiple choices, the relay content provided may be determined based on a choice selected through the user's interaction with the selection interface. Specifically, the relay content provided may be a relay content provided upon the selection of the selected choice.

In another example, the relay content provided may be determined based on a relationship between the first user and the second user. Specifically, if the second user among the relay content providers is a friend of the first user, a relay content provided by the second user may be provided with priority over other relay contents.

In yet another example, the server 10 may obtain information about preferences, tastes, or the like of the first user terminal 20, and may determine which relay content to be provided from among multiple relay contents based on the information about the preferences, tastes, or the like.

When multiple relay contents are subordinate to a source content, one relay content selected as described above may be provided to the first user terminal 20, followed by other relay contents sequentially. Accordingly, the first user terminal 20 is able to continuously play multiple relay contents subordinate to the same source content.

In operation 207, the first user terminal 20 may receive a relay content from the server 10 and play the received relay content. At this point, while playing the relay content, the first user terminal 20 may display information about the source content to which the relay content is subordinate. This enables the first user to view the information about the source content of the currently playing relay content

In some cases, the information about the source content may be displayed in the form of an interface that enables playback of the source content. Accordingly, the first user terminal 20 is able to return from the relay content to the source content and play the source content.

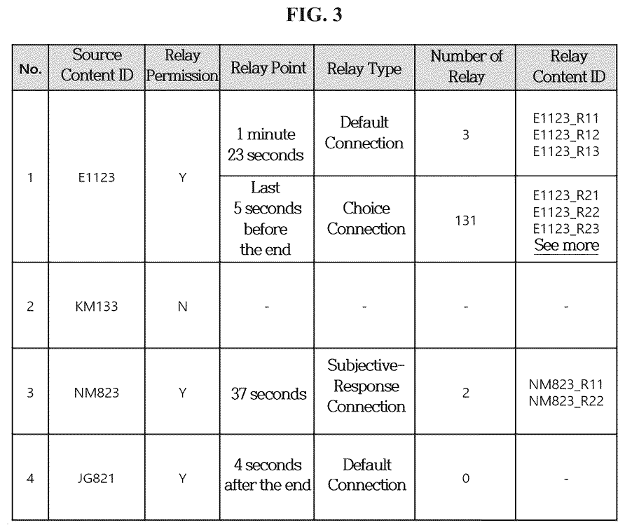

Hereinafter, an example of a method for providing a relay content to the first user terminal 20 by the server 10 will be described with reference to FIGS. 3 to 10.

FIG. 3 is an exemplary table organizing a database of contents held by the server 10 to perform a method for providing a relay content to the first user terminal 20. Here, the fact that the server 10 holds contents may mean that the server 10 either stores information about the contents or has the authority to access such information and thus is ready to provide the contents to a user terminal.

Referring to FIG. 3, the database may include information about multiple source contents. The database may include information on relay permission for each source content. The relay permission indicates whether or not a relay content can be registered as subordinate to the source content.

The database may include information on a relay point for a source content where relaying is allowed. As in the example of FIG. 3, one or more relay points may be set in a single source content.

In addition, the database may include information on a relay type for each relay point. The relay type may include: a default connection type in which a relay content is subordinately connected at a corresponding relay point; and a choice connection type in which choices are provided and a relay content is subordinately connected to a selected choice in response to the user's choice.

In addition, the database may include the number of relay contents registered at each relay point, and identification information (ID) of each relay content. Multiple relay contents may be registered at one relay point. In this case, the multiple relay contents may be provided sequentially to a user terminal.

Referring to FIG. 3, it may be seen that relaying is allowed for a source content E1123. In addition, for the source content E1123, a relay point of the default connection type is set at 1 minute and 12 seconds of the source content E1123, and a relay point of the choice connection type is set at the last 5 seconds before the end of the source content E1123. In addition, it may be seen that 3 relay contents are registered at the relay point at 1 minute and 12 seconds of the source content E1123, and 131 relay contents are registered at the relay point of the last 5 seconds before the end of the source content E1123.

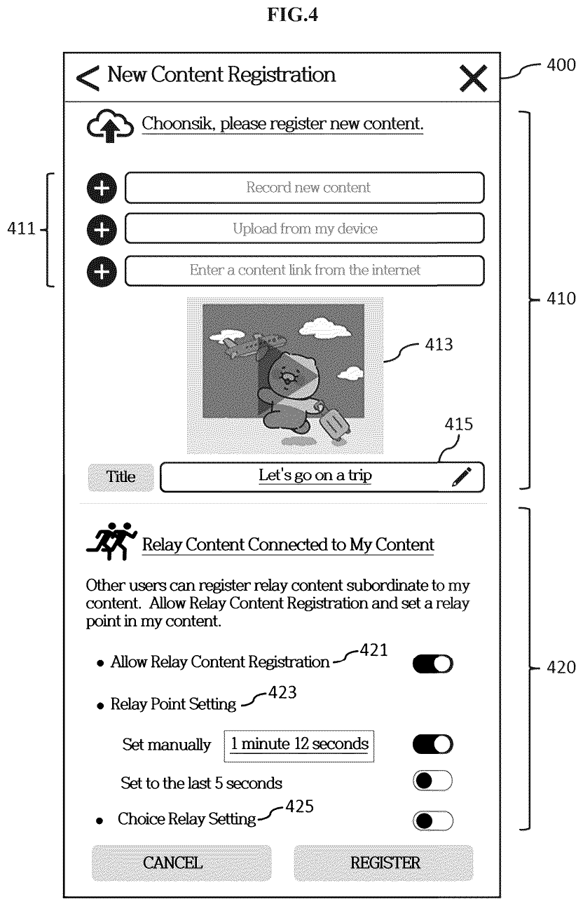

Hereinafter, an embodiment of the present disclosure will be described in detail with reference to FIGS. 4 to 10, using the source content E1123 and a relay content subordinate thereto as examples.

FIGS. 4 to 10 illustrate screens of a user terminal according to one embodiment of the present disclosure.

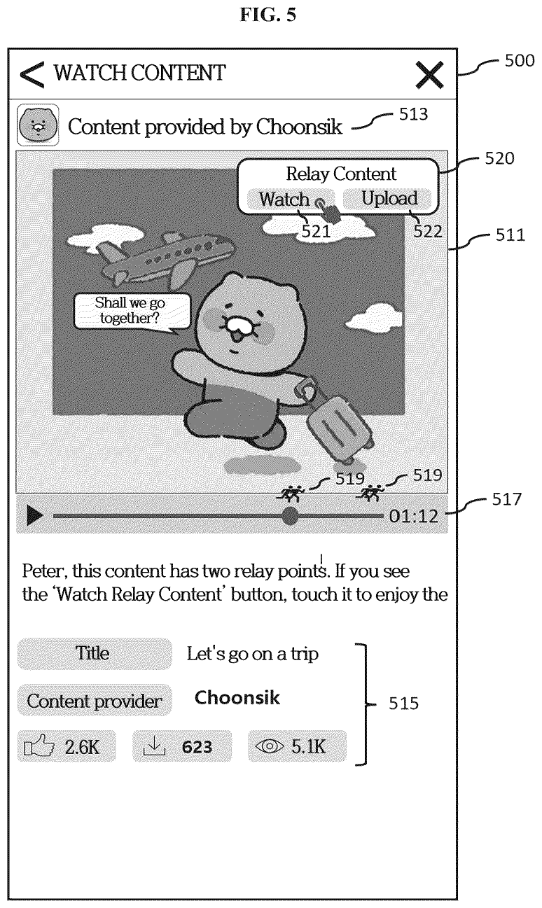

FIGS. 4 and 7 are example screens of a source content provider terminal, and FIGS. 5, 6, 8, 9 and 10 are example screens of a first user terminal 20. In the examples of FIGS. 4 to 10, a source content provider is “Choonsik”, a first user is “Peter”, and second users (relay content providers) are “Ryan” and “Frodo”.

FIG. 4 illustrates a screen 400 during a process in which a source content provider terminal provides a source content to the server 10 before the server 10 performs operation 201 of FIG. 2.

Referring to FIG. 4, the server 10 may provide the source content provider terminal with an interface 410 for providing a source content to the server 10.

The source content provider terminal may provide the source content to the server 10 in various ways. Specifically, the source content provider terminal may provide contents to the server 10 by recording a new content with the source content provider terminal, uploading a content stored in the source content provider terminal, entering a link to a content posted online to the server 10, or the like. The server 10 may provide the source content provider terminal with an interface 411 for providing a source content by selecting at least one of the various ways.

The source content provider terminal may input basic information, such as a title 415 of a source content 413, and provide the basic information to the server 10.

In addition, the server 10 may provide the source content provider terminal with an interface 420 for configuring relay content setting information for the source content.

Specifically, the source content provider terminal may provide the server 10 with information 421 on whether to allow relay content registration for the source content, setting information 423 for a relay point if the relay content registration for the source content is allowed, setting information 425 on whether a relay type is choice relay, and so on.

FIG. 5 illustrates an example screen 500 displayed on a first user terminal 20 during a process in which the server 10 performs operations 201 to 205 of FIG. 2.

Referring to FIG. 5, the first user terminal 20 may receive and play a source content from the server 10. While playing the source content 511, the first user terminal 20 may display basic information 513 and 515 (a source content provider, a source content title, etc.) about a source content 511.

At least one relay point may be set in the source content. The first user terminal 20 may display information about a relay point set in the source content. Specifically, as shown in FIG. 5, information 519 corresponding to a relay point may be displayed on a playback bar 517 of the source content.

When the first user terminal 20 plays a portion corresponding to the relay point in the source content, the first user terminal 20 may display a relay playback interface 520 for the source content. As shown in FIG. 5, the relay playback interface 520 may be displayed overlapping an area 511 where the source content is displayed.

The relay playback interface 520 may include an interface 521 for playing a relay content subordinate to the source content, and an interface 522 for providing a new relay content subordinate to the source content to the server 10.

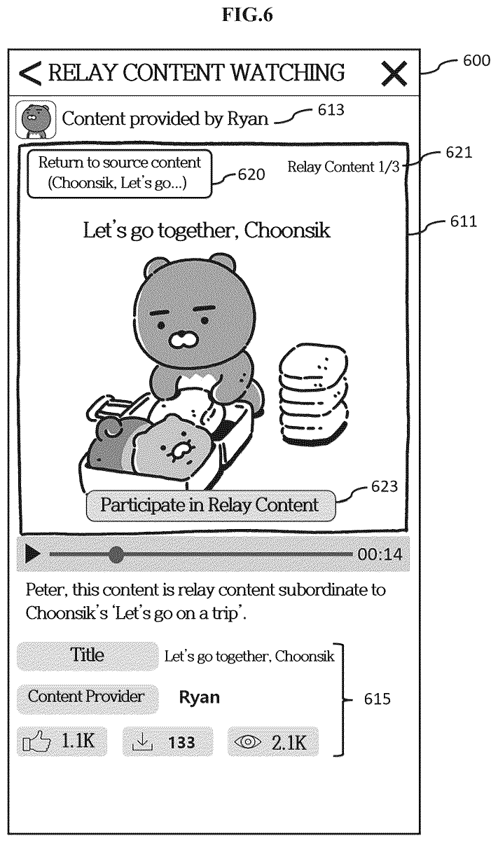

FIG. 6 illustrates an example screen 600 displayed on the first user terminal 20 during a process in which the server 10 performs operation 207 of FIG. 2.

Referring to FIG. 6, the first user terminal 20 may receive and play a relay content 611 subordinate to a source content from the server 10. While playing the source content, the first user terminal 20 may display basic information (a relay content provider, a relay content title, etc.) 613 and 615 about the relay content.

While playing the relay content, the first user terminal 20 may display information about the source content to which the relay content is subordinate. As illustrated in FIG. 6, information 620 about the source content may be displayed overlapping an area 611 where the relay content is displayed.

The information about the source content 620 may be an interface for playing the source content. When the first user inputs an interaction with the interface 620, the first user terminal 20 may stop playing the currently playing relay content 611 and switch to the screen 500 to play the source content.

While playing the relay content, the first user terminal 20 may display information about every relay content registered at the corresponding relay point in the source content. For example, as illustrated in FIG. 6, the first user terminal 20 may display information indicating that three relay contents are registered at the relay point at 1 minute and 12 seconds of the source content, and that the first relay content among the three relay contents is currently being played.

While playing the relay content, the first user terminal 20 may display a new relay registration interface 623. The new relay content registered through the interface 623 may be provided as subordinate to the same source content as that of the currently playing relay content.

As illustrated in FIG. 5, when two or more relay points are set in the source content, the new relay content registered through the interface 623 may be registered at the same relay point at which the currently playing relay content is registered.

Hereinafter, an example where a relay content is a choice relay type will be described with reference to FIGS. 7 to 10.

FIG. 7 illustrates a screen 700 during a process in which a source content provider terminal provides a source content to a server 10 before the server 10 performs operation 201 of FIG. 2. FIG. 7 illustrates that, unlike FIG. 4, the source content provider sets the relay type for the source content to a choice relay.

While providing the source content to the server 10, the source content provider terminal may set a relay type for a specific relay point in the source content to a choice relay type 711.

Referring to FIG. 4 and FIG. 7, it is illustrated that the provider terminal of the source content sets a relay point at 1 minute and 12 seconds of the source content to a general relay type (not a choice relay type) (as indicated by reference numeral 425 in FIG. 4), while a relay point of the last 5 seconds before the end of the source content is set to a choice relay type (as indicated by reference numeral 711 in FIG. 7).

If the relay type is a choice relay type, the source content provider terminal may provide the server 10 with question information 712 regarding choices and information 713 about at least one choice that other users may select.

FIG. 8 illustrates an example screen 800 displayed on the first user terminal 20 during a process in which the server 10 performs operations 201 to 205 of FIG. 2.

FIG. 8 illustrates a screen in which the first user terminal 20 plays a source content with choice relay set as shown in FIG. 7.

When the first user terminal 20 plays a portion corresponding to a relay point 819 that is set to choice relay in the source content, the first user terminal 20 may display a relay playback interface 820 for the corresponding relay point in the source content. In this case, the relay playback interface 820 may be a selection interface.

The selection interface 820 may include question information 822 and at least one choice information 823. The first user terminal 20 may receive a selection interaction from the first user to select any one choice in the choice information 823.

The choice information 823 may include profile information 827 and 828 of users who provided relay contents related to the selected choice.

If multiple relay content providers are associated with a particular choice, the profiles of at least some of the providers may be selectively displayed in the choice information 823. Specifically, each of the profile information 827 and 828 may be determined based on a relationship between the first user and a user corresponding to the profile information. Here, the relationship may be established in relation to a service through which the server 10 provides a content. For example, if a second user is a friend with the first user among relay content providers, the second user's profile information may be displayed with priority over profile information for other relay content providers.

In some cases, the first user may input an interaction to select any of the profile information 827 and 828 in the choice information 823, and in this case, the server 10 may provide a relay content provided by a user corresponding to the selected profile information to the first user terminal 20.

For example, for the choice information 823 illustrated in FIG. 8, when the first user inputs an interaction with the profile information 827, a relay content provided by the user corresponding to the profile information 827 may be played. In this way, the first user may select and play any one of the multiple relay contents registered to a specific choice.

The selection information 823 may display detailed information about every relay content registered for each choice. For example, as illustrated in FIG. 8, the choice “Let's go to the mountains!” may display relay content count information 829, showing that the total number of relay contents registered for the choice is 75.

If multiple relay contents are registered for the selected choice, a relay content to be provided may be determined based on a relationship between the first user and each relay contents provider. Specifically, if the second user among the relay content providers is a friend of the first user, a relay content provided by the second user may be provided with priority over other relay contents.

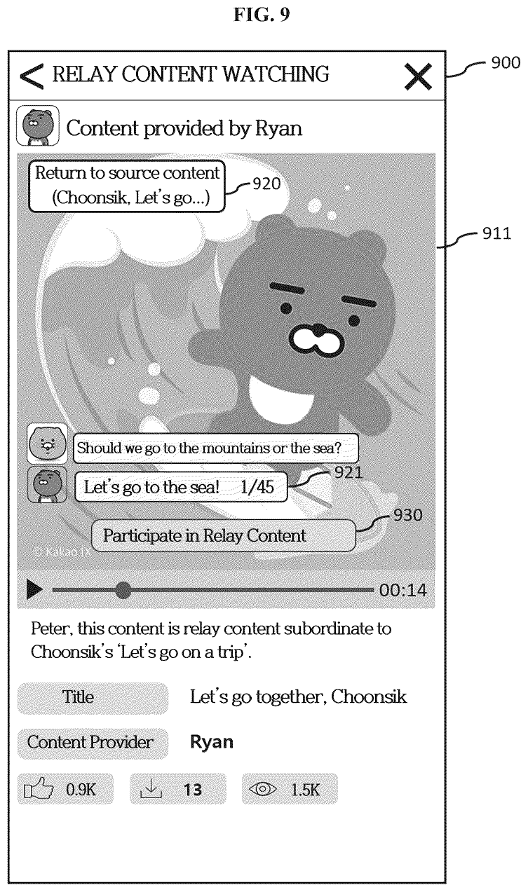

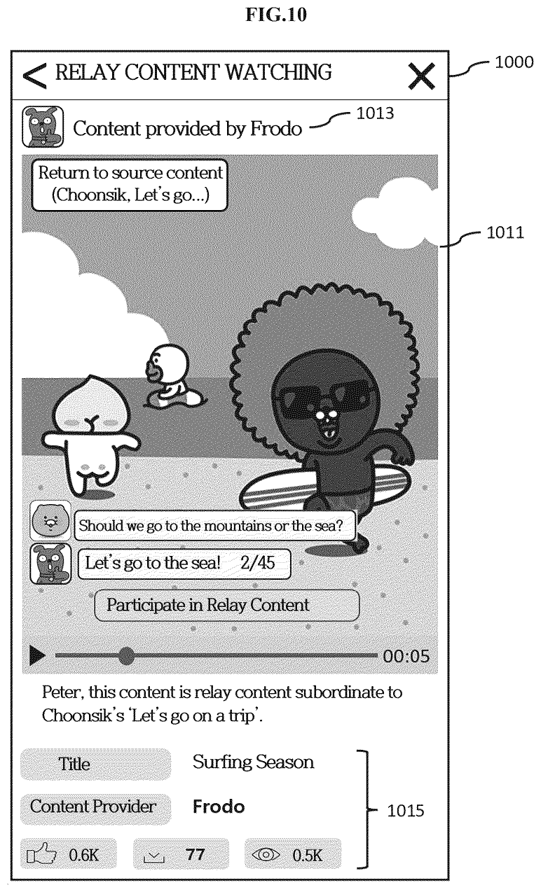

Referring to the examples of FIGS. 8 to 10, there may be a case where the first user “Peter” and a relay content provider “Ryan” are friends, but “Frodo” is not a friend. In this case, when the server 10 receives an interaction with the choice “Let's go to the sea!” 823 from the first user terminal 20 (see FIG. 8), the server 10 may first provide a relay content 911 provided by “Ryan” to the first user terminal 20 (see FIG. 9) and then later provide a relay content 1011 provided by “Frodo” (see FIG. 10).

FIG. 9 illustrates an example screen 900 displayed on a first user terminal 20 during a process in which the server 10 performs operation 207 of FIG. 2.

FIG. 9 is a screen displayed in response to an interaction with the choice “Let's go to the sea!” in the choice information 823 in FIG. 8.

Referring to FIG. 9, the first user terminal 20 may receive and play a relay content 911 subordinate to a source content from the server 10. The relay content 911 may be a relay content registered for the choice “Let's go to the sea!” selected by a user in FIG. 8.

While playing the relay content 911, the first user terminal 20 may display information 920 about the source content to which the relay content is subordinate. As illustrated in FIG. 9, the information 920 about the source content may be displayed overlapping an area 911 where the relay content is displayed. The information 920 about the source content may be an interface for playing the source content.

While playing the relay content, the first user terminal 20 may display information 921 about the choice “Let's go to the sea!”, for which the relay content is registered. This choice may be the same as the choice selected by the first user on the screen of FIG. 8.

In addition, the information 921 about the choice may include details on the position of the currently playing relay content among all the relay contents registered for the choice. For example, as illustrated in FIG. 9, the first user terminal 20 may display information that there are 45 relay contents registered for the choice “Let's go to the sea!” at the relay point in the source content, and that the first relay content among the relay contents is currently being played.

While playing the relay content, the first user terminal 20 may display a new relay registration interface 930. A new relay content registered through the interface 930 may be provided as subordinate to the same source content as that of the currently playing relay content.

As illustrated in FIG. 8, when the relay point in the source content is a choice relay point, a new relay content registered through the interface 930 may be registered as subordinate to the choice for which the currently playing relay content is registered.

For example, when the first user terminal 20 provides a new relay content to the server 10 through the interface 930, the new relay content may be registered as subordinate to the choice “Let's go to the sea!” at a relay point of the last 5 seconds of the source content 811, specifically from 1 minute 30 seconds to 1 minute 35 seconds before the end of the source content 811.

FIG. 10 illustrates an example screen 1000 displayed on the first user terminal 20 during a process in which the server 10 performs operation 207 of FIG. 2.

FIG. 10 illustrates a screen for playing another relay content 1011 after the playback of the relay content 911 in FIG. 9.

When multiple relay contents are registered for the choice selected by the first user, one relay content 911 selected as described above may be first provided to the first user terminal 20 and another relay content 1011 may be then provided sequentially. Accordingly, the first user terminal 20 is able to continuously play multiple relay contents subordinate to the same source content.

Referring to FIGS. 9 and 10, the first user terminal 20 may first play one relay content 911 and then play another relay content 1011 registered for the same choice. Referring to information about other relay contents 1013 and 1015, the multiple relay contents 911 and 1011 may be relay contents provided by different users.

FIG. 11 is a flowchart for explaining a method in which the user terminal 20 of the present disclosure provides a new relay content to the server 10.

For convenience of explanation, the description of operations in FIG. 11 that are substantially identical to operations in FIG. 2 will be replaced by the description in FIG. 2.

In operation 1101, the server 10 provides a source content to the first user terminal 20. Since operation 1101 is substantially identical to operation 201 of FIG. 2, a detailed description of operation 1101 will be replaced by that of operation 201 of FIG. 2.

In operation 1103, the server 10 determines whether the first user terminal 20 plays a relay point in the source content.

Here, the first user terminal 20 playing a relay point in the source content may be substantially equivalent to the first user terminal 20 playing the source content while meeting a relay content playback condition in operation 203 of FIG. 2. Therefore, the detailed description of operation 1103 and operation 1109 will be replaced by that of operation 203 and operation 209 of FIG. 2.

In operation 1105, the server 10 provides the first user terminal 20 with an interface (new relay registration interface) for providing a new relay content to the server 10.

When the server 10 verifies whether the first user terminal 20 plays the relay point in the source content in operation 1103, the first user terminal 20 may display the new relay registration interface.

Here, the new relay registration interface may be displayed along with the source content when the first user terminal 20 plays the source content. This is distinguished from the new relay registration interfaces 623 and 930 illustrated in FIG. 6 and FIG. 9, which are displayed along with a relay content when the first user terminal 20 plays the relay content. This method has the advantage that the first user terminal can display the new relay registration interface while playing only the source content, without having to play the relay content.

The new relay registration interface may be displayed in the same manner as the relay playback interface described in operation 205 of FIG. 2. In some cases, the new relay registration interface may be displayed along with the relay playback interface.

The new relay registration interface may disappear and no longer be displayed if no interaction is received within a predetermined time after the new relay registration interface is displayed on the first user terminal 20. This may be because the absence of interaction is interpreted as a lack of intention to provide a new relay content to the server 10, which leads to a follow-up action. In such cases, if the source content has not yet ended, the source content may continue to be played, and if the source content has ended, another content may be played.

The new relay registration interface may be provided in various types depending on the relay type. As an example, if the relay type is the default connection type, the new relay registration interface may be displayed in the form of a single interface, such as “Connect relay content”, at the relay point in the source content.

As another example, if the relay type is the choice connection type, the new relay registration interface may be displayed in the form of a selection interface for selecting one of multiple choices.

As yet another example, if the relay type is a subjective-response connection type, the new relay registration interface may be displayed in the form of an input interface such as “Please enter an answer related to the relay content.”

In operation 1107, the server 10 stores the new relay content provided by the first user terminal 20 as a relay content of the source content.

When the server 10 receives the new relay content from the first user terminal 20, the server 10 may store the new relay content in a database.

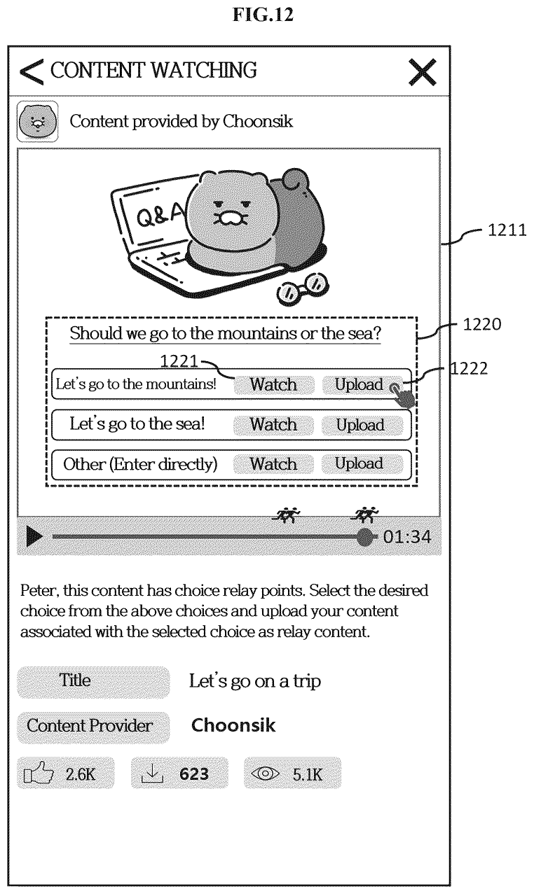

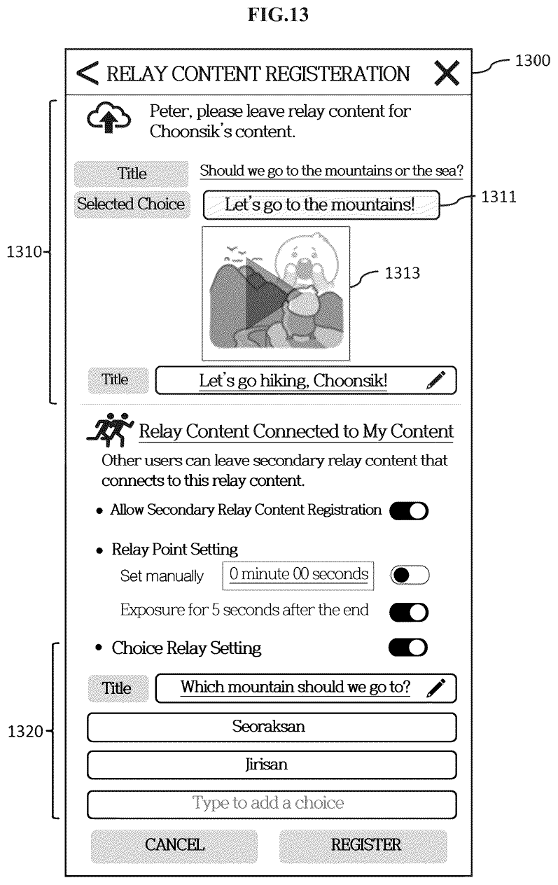

Hereinafter, an example of a method in which the server 10 receives a relay content from the first user terminal 20 will be described with reference to FIGS. 12 and 13.

FIGS. 12 and 13 are example screens of the first user terminal 20. In the examples of FIGS. 12 and 13, the source content provider is “Choonsik” and the first user is “Peter”, for illustrative purposes.

FIG. 12 illustrates an example screen 1200 displayed on the first user terminal 20 during a process in which the server 10 performs operations 1101 to 1105 of FIG. 11. FIG. 11 illustrates a new relay registration interface displayed along with a playback interface for a choice relay, unlike FIG. 8.

Referring to FIG. 12, when the first user terminal 20 plays a portion corresponding to a relay point in the source content, the first user terminal 20 may display a relay interface 1220 for the source content.

As illustrated in FIG. 12, the relay interface 1220 may include a relay playback interface 1221 and a new relay registration interface 1222. Specifically, when the relay point is set to a choice type, the relay playback interface 1221 and the new relay registration interface 1222 for each selection may be displayed. A new relay content registered through the new relay registration interface 1222 for a specific choice may be stored as a relay the choice.

FIG. 13 illustrates a screen 1300 of a process in which a first user terminal 20 provides a new relay content to a server 10 while the server 10 performs operation 1107 of FIG. 2.

The screen of FIG. 13 may be displayed upon receiving an interaction with the new relay registration interface 1222 in FIG. 12.

Referring to FIG. 13, the server 10 may provide an interface 1310 for providing a new relay content 1311 to the first user terminal 20 to the server 10.

The first user terminal 20 may display information 1311 about a choice selected by the first user to register a new relay content. The new relay content registered through the interface 1310 may be saved as a relay content related to the selected choice.

In addition, the server 10 may provide the first user terminal 20 with an interface 1320 for configuring relay content information for a relay content. Another user terminal playing the relay content provided by the first user may provide the server 10 with a secondary relay content subordinate to the corresponding relay content.

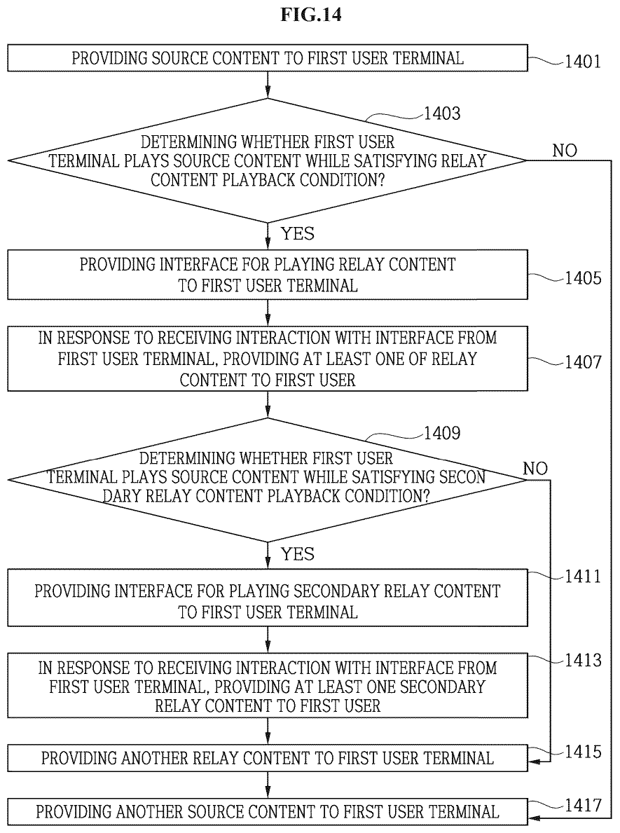

FIG. 14 is a flowchart for explaining a method for providing at least one secondary relay content to a first user terminal 20 by a server 10 of the present disclosure.

For convenience of explanation, the description of operations in FIG. 14 that are substantially identical to operations in FIG. 2 will refer to the description in FIG. 2.

Since operations 1401 to 1407 are substantially identical to operations 201 to 207 in FIG. 2, the description of operations 1401 to 1407 will be replaced by that of operations 201 to 207 in FIG. 2.

In operation 1409, the server 10 determines that the first user terminal 20 plays the relay content while meeting a secondary relay content playback condition.

While playing the relay content, the first user terminal 20 may determine whether to sequentially play other relay contents subordinate to the source content or to play a secondary relay content subordinate to the currently playing relay content.

When secondary relay content registration for the relay content being played by the first user terminal 20 is allowed and a relay point for secondary relay has been set, the server 10 may provide an interface for playing a secondary relay content. To this end, the server 10 may determine whether the first user terminal 20 plays the relay content while meeting a secondary relay content playback condition.

Here, the secondary relay content playback condition may be substantially similar to the relay content playback condition described in operation 203 of FIG. 2. Therefore, detailed descriptions of the secondary relay content playback condition will be omitted.

When the first user terminal 20 stops playing the relay content midway or requests playback of another content subordinate to the source content, it may be determined that the secondary relay content playback condition is not met. In this case, operation 1415 is performed so that the server 10 provides the first user terminal 20 with another relay content subordinate to the source content. In some cases, operation 1417 may be performed so that the server 10 provides the first user terminal 20 with another source content.

In operation 1411, the server 10 provides the first user terminal 20 with an interface for playing a secondary relay content. Since operation 1411 is identical to operation 205 of FIG. 2, except that a secondary relay content is provided instead of a relay content, the description of operation 1411 will be replaced by that of operation 205 in FIG. 2.

In operation 1413, when an interaction with the interface for playing a secondary relay content is received from the first user terminal 20, the server 10 provides at least one secondary relay content to the first user terminal 20. Since operation 1413 is similar to operation 207 in FIG. 2, any redundant parts in the description of operation 1413 will be replaced by that of operation 207 in FIG. 2.

In operation 1413, the first user terminal 20 may receive and play a secondary relay content from the server 10. While playing the secondary relay content, the first user terminal 20 may display information about the source content and specific relay content to which the secondary relay content is subordinate. This enables the first user to view information about the source content and specific relay content related to the currently playing secondary relay content.

In some cases, the information about the source content and specific relay content may be displayed in the form of an interface that enables playback of the source content or specific relay content. This enables the first user terminal 20 to return from the secondary relay content to the source content or specific relay content and play the source content or specific relay content.

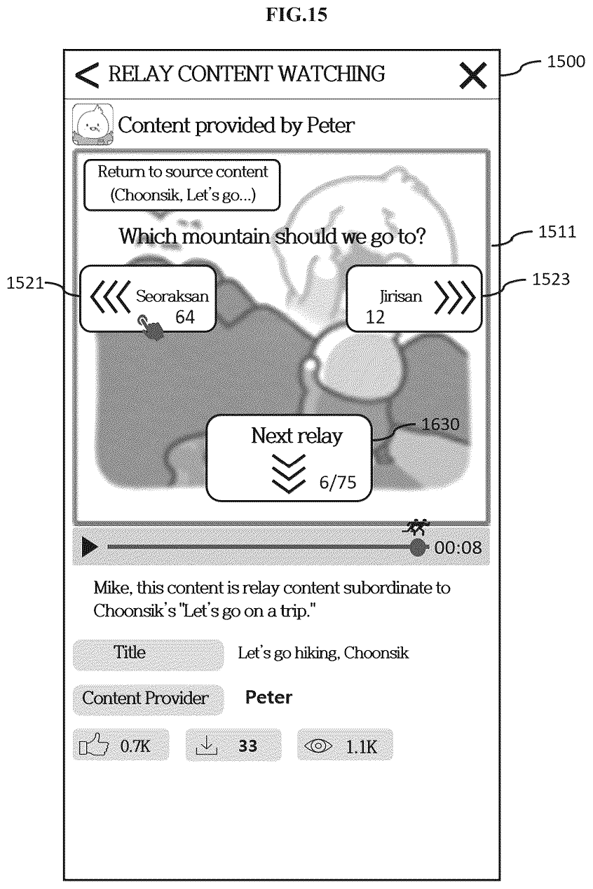

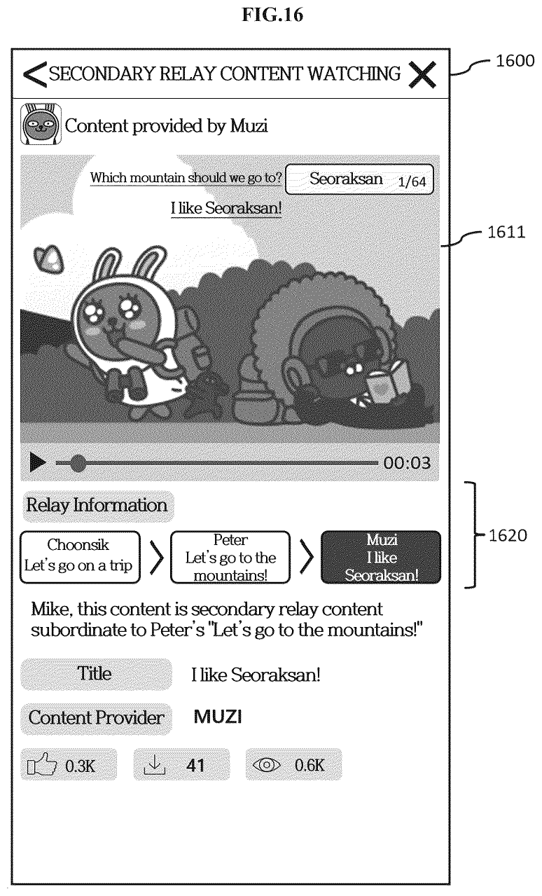

FIGS. 15 and 16 illustrate screens of a user terminal according to one embodiment of the present disclosure.

FIGS. 15 and 16 are example screens of the first user terminal 20. Unlike the examples in FIGS. 4 to 10 and 12 to 13, the examples in FIGS. 15 to 16 will be explained using the first user ‘Mike’, the relay content provider (second user) ‘Peter’, and the secondary relay content provider ‘MUZI’ as examples.

FIG. 15 illustrates an example screen 1500 displayed on the first user terminal 20 during a process in which the server 10 performs operation 1409 to 1411 of FIG. 14.

The screen of FIG. 15 may be displayed when the first user terminal 20 plays a portion corresponding to a relay point in a relay content.

Referring to FIG. 15, the first user terminal 20 may display secondary relay playback interfaces 1521 and 1523 and an interface 1530 for playing another relay content. This enables the first user to select and request playback of either a secondary relay content or another relay content subordinate to a source content.

The secondary relay playback interfaces 1521 and 1523 may be displayed in various ways. As illustrated in FIG. 15, each of the secondary relay playback interfaces 1521 and 1523 may, for example, be displayed in the form of a swipe interface.

The interface 1530 for playing another relay content may be displayed in various ways. As illustrated in FIG. 15, the interface 1530 for playing another relay content may also be displayed in the form of a swipe interface.

In this case, the swipe directions of the secondary relay playback interfaces 1521 and 1523 and the interface 1530 may be set differently.

FIG. 16 illustrates an example screen 1600 displayed on the first user terminal 20 during a process in which the server 10 performs operation 1413 of FIG. 14.

FIG. 16 may be displayed when an interaction is input to the secondary relay playback interface 1521 in FIG. 15.

Referring to FIG. 16, the first user terminal 20 may receive a secondary relay content 1611 from the server 10 and play the secondary relay content 1611.

While playing the secondary relay content 1611, the first user terminal 20 may display relay information 1620. The relay information 1620 may include information about the source content and relay content played by the first user terminal. Specifically, the relay information 1620 may include information about the source content and relay content to which the secondary relay content is subordinate. This relay information 1620 may display the dependency relationships of the contents in sequence.

In some cases, a currently playing relay content may be a tertiary or quaternary relay content. In such cases, multiple relay contents may be displayed in the relay information. In such cases, the relay information may be shown concisely by omitting at least some of the subordinate relay contents.

The relay information 1620 may be displayed in the form of an interface for playing the source content or specific relay content. This allows the first user terminal 20 to return from the secondary relay content to the source content or specific relay content and play the source content or specific relay content.

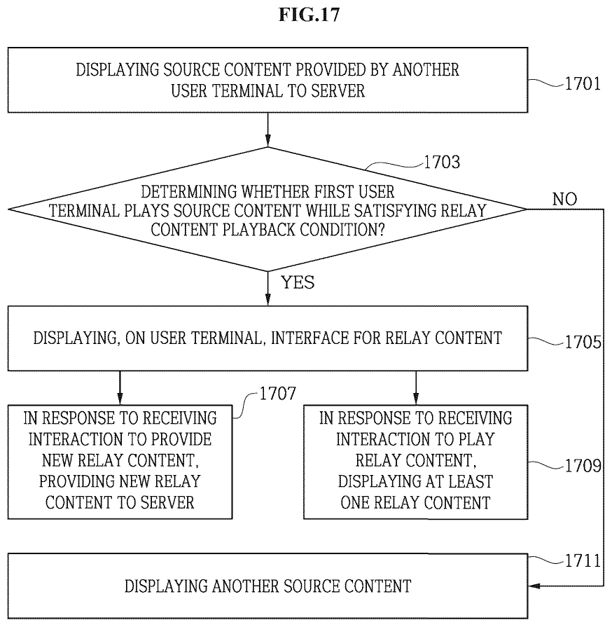

FIG. 17 is a flowchart for explaining a method for displaying a source content and a relay content by a user terminal 20 of the present disclosure.

For convenience of explanation, the description of operations in FIG. 17 substantially identical to those in FIG. 2 or FIG. 11 will be replaced by the description in FIG. 2 or FIG. 11.

In operation 1701, the first user terminal 20 displays a source content provided by another user terminal to the server 10. Since operation 1701 is substantially identical to operation 1101 of FIG. 11, the description of operation 1701 will be replaced by that of operation 1101 of FIG. 11.

In operation 1703, it is determined whether the first user terminal 20 plays the source content while meeting a relay content playback condition. Since operation 1703 is substantially identical to operation 1103 of FIG. 11, the description of operation 1703 will be replaced by that of operation 1103 of FIG. 11.

In operation 1705, an interface for a relay content is displayed on the first user terminal 20. Since operation 1705 is substantially identical to operation 1105 of FIG. 11, the description of operation 1705 will be replaced by that of operation 1105 of FIG. 11.

In operation 1707, when an interaction to provide a new relay content is received, the first user terminal 20 may provide a new relay content to the server 10. Since operation 1707 is substantially identical to operation 1107 of FIG. 11, the description of operation 1707 will be replaced by that of operation 1107 in FIG. 11.

In operation 1709, when an interaction to play a relay content is received, the first user terminal 20 displays at least one relay content. Since operation 1709 is substantially identical to operation 207 of FIG. 2, the description of operation 1709 will be replaced by that of operation 207 of FIG. 2.

The present disclosure has an advantage in that it provides source content and provides relay content that is played continuously based on choice information for any one of multiple choices associated with the source content.

The method for providing a relay content subordinate to a source content in the present disclosure has the advantage of providing a point at which a relay content is uploaded or played, by including a relay point in the source content.

The technical features disclosed in each embodiment of the present disclosure are not limited to a corresponding embodiment, and, unless they are mutually incompatible, the technical features disclosed in each embodiment may be combined and applied to different embodiments.

Therefore, each embodiment will focus on explaining each technical feature, but unless each technical feature is incompatible with the others, they can be combined and applied together.

The present disclosure is not limited to the above-described embodiments and the accompanying drawings, and various modifications and variations will be possible for a person skilled in the art to which the present disclosure pertains. Therefore, the scope of the present disclosure should be defined not only by the claims of this specification but also by equivalents of these claims.

What is claimed is:

1. A method for providing a relay content by a server, comprising:
providing a source content to a first user terminal;
identifying that the first user terminal plays the source content, satisfying a relay content playback condition; and
providing at least one relay content to the first user terminal,
wherein the at least one relay content is subordinate to the source content, and
wherein the source content and the at least one relay content are provided by different users.

2. The method of claim 1, wherein the at least one relay content is received from a second user terminal after the server provides at least a part of the source content to the second user terminal.

3. The method of claim 1, wherein the relay content playback condition is associated with whether the first user terminal plays a predetermined relay point in the source content.

4. The method of claim 3, wherein the predetermined relay point is associated with at least one of a specific point and a specific segment in the source content.

5. The method of claim 1, wherein providing the at least one relay content comprises:
providing a playback interface for the at least one relay content to the first user terminal; and
in response to receiving an interaction with the interface from the first user terminal, providing the at least one relay content to the first user terminal.

6. The method of claim 5, wherein:
the interface is a selection interface for selecting one of multiple choices, and
the relay content is associated with the choice selected by the interaction.

7. The method of claim 6, wherein the selection interface comprises profile information for at least one of users providing relay contents associated with the multiple choices.

8. The method of claim 7, wherein the profile information is determined based on a relationship between a first user and the at least one user corresponding to the profile information, wherein the relationship is established in relation to a service through which the server provides contents.

9. The method of claim 1, wherein:
in providing the at least one relay content, the server sequentially provides multiple relay contents, and
the multiple relay contents are subordinate to the source content.

10. The method of claim 9, wherein a playback order of the multiple relay contents is determined based on a relationship between a first user and users providing the multiple relay contents, wherein the relationship is established in relation to a service through which the server provides contents.

11. The method of claim 1, wherein providing the at least one relay content comprises providing information about the source content along with the at least one relay content.

12. The method of claim 1, further comprising, after providing the source content, providing the first user terminal with an interface for providing a new relay content subordinate to the source content to the server.

13. The method of claim 12, wherein:
the interface is a selection interface for selecting one of multiple choices, and
the new relay content is associated with a choice selected through an interaction with the selection interface.

14. The method of claim 1, further comprising, after providing the at least one relay content:
determining whether the first user terminal plays a specific relay content while meeting a secondary relay content playback condition; and
providing at least one secondary relay content to the first user terminal,
wherein the secondary relay content is subordinate to the specific relay content, and
wherein the specific relay content and the secondary relay content are provided by different users.

15. The method of claim 14, wherein providing the at least one secondary relay content comprises providing information about at least one of the source content and the relay content being played, along with the secondary relay content.

16. A server providing a relay content, comprising:
a memory storing instructions, and
a processor connected to the memory and configured to execute the instructions to:
provide a source content to a first user terminal;
identify that the first user terminal plays the source content, satisfying a relay content playback condition; and
provide at least one relay content to the first user terminal,
wherein the at least one relay content is subordinate to the source content, and
wherein the source content and the at least one relay content are provided by different users.

17. A method for displaying a relay content by a user terminal, comprising:
displaying a source content provided to a server by another user terminal; and
displaying an interface for providing a new relay content subordinate to the source content to the server.

18. The method of claim 17, wherein:
the interface is a selection interface for selecting one of multiple choices, and
the new relay content is associated with the choice selected by an interaction with the selection interface.

19. The method of claim 17, further comprising:
in response to displaying the source content while meeting a relay content playback condition, displaying a relay content playback interface; and
in response to receiving an interaction with the relay content playback interface, displaying at least one relay content.

20. The method of claim 19, wherein:
the playback interface is a selection interface for selecting one of multiple choices, and
the relay content is associated with a choice selected through the interaction.
